(19) United States
(12) Patent Application Publication
(10) Pub. No.: US 2008/0163667 A1
(43) Pub. Date: Jul. 10, 2008

(54) Device for the Evaluation of Ski Wax

(76) Inventor: Tomas Lackman, Arsta (SE)

Correspondence Address: OSTROLENK FABER GERB & SOFFEN, 1180 AVENUE OF THE AMERICAS, NEW YORK, NY, 100368403, US

(21) Appl. No.: 10/598,599

(22) PCT Filed: Feb. 15, 2005
(86) PCT No.: PCT/SE2005/000198

§ 371 Date: Sep. 5, 2006

(30) Foreign Application Priority Data
Mar. 5, 2004 (SE) 0400547-6

(51) Int. Cl. G01N 3/56

(52) U.S. Cl. 73/9

(57) ABSTRACT

Device for the evaluation of at least one friction property of a ski wax against the surface of snow in a skiing track, comprising a disc carried by a stand and having a substantially planar working surface, on which a layer of wax that is to be evaluated is applied, members for the pressing of the disc by a preselected force against the snow surface and driving members for the driving of the disc in relation to the snow surface. The driving members comprise an electric motor having a known relationship between the electric power consumption of the electric motor and the braking power of the disc and that means are provided for the readout of the electric power consumption of the motor, at least in the beginning of the displacement of the disc in relation to the snow surface.

The invention relates to a device for the evaluation of the friction of a ski wax against a snow surface in a skiing track, of the kind that is seen in the preamble of claim 1.

In order to evaluate a ski wax in respect of friction against a snow surface in a skiing track, it is previously known, for instance from U.S. Pat. No. 4,890,477, to apply a layer of the wax on one of the principal surfaces of a disc, which is rotatable around a centrally located normal axis during pressing of the waxed principal surface against the snow surface, the disc being rotationally driven by a mechanical spring device after the same has been loaded with a predetermined amount of energy, and the rotation of the disc, for instance the number of rotation turns, being evaluated.

However, such a mechanical device gives relatively uncertain results. Therefore, an object of the invention is to provide a simple device, which gives a high reliability in respect of the evaluation of the wax in question.

An additional object the invention is to provide a device, which readily affords static friction as well as dynamic friction to the waxed side of the disc against the snow surface.

An additional object of the invention is to provide a device, which also enables compensation for substantially constant factors upon the evaluation of the friction.

An additional object is to provide a device the evaluation members of which can be set to zero in respect of the wax that offers the most favourable static or dynamic friction, so that the next wax being evaluated and having an inferior friction against the snow does not give any result in the evaluation members.

One or more of the objects are attained entirely or partly by the invention.

The invention is defined in the appended claim 1.

Embodiments of the invention are defined in the appended dependent claims.

An important feature of the invention is that for the drive of the disc carrying the wax, an electric motor is utilized. Preferably, in that connection, an electric motor is pursued having a substantially linear relationship between the power consumption and the exerted torque, especially at a substantially constant voltage so that the friction of the wax against the snow substrate is substantially proportional to the current consumption of the motor. In that case, it is simple to read and register the friction of the wax against the snow surface, both in respect of the static coefficient of friction, in connection with a rotation starting to appear between the snow surface and the waxed surface of the disc, and the dynamic coefficient of friction, when a stable relative motion is at hand between the waxed surface of the disc and the snow surface.

Preferably, the disc is rotatable around a centrally located normal to the waxed surface thereof, the disc suitably being circular and rotationally driven around the axis thereof by the electric motor. For cross-country skiing, it is particularly important, among a plurality of available types/kinds of waxes, to evaluate the wax that presents a sufficient static friction in order to offer an acceptable so-called bite. Furthermore, then of course also the dynamic coefficient of friction is of interest, so that it is possible to find, among the waxes that offer a correct bite, the wax that has the lowest dynamic friction. At a certain relative speed in relation to the snow surface of a rotationally driven disc, the wax is suitably rotationally symmetrically applied, for instance in a ring-shaped zone that is concentric with the rotation axis. Alternatively, a circular surface, concentric with the rotation axis, may be coated with wax.

The device according to the invention requires relatively low driving power and can, therefore, be driven by an electric accumulator having a substantially constant driving voltage, so that the current consumption of the motor is detected and is representative of the friction of the wax. When, as an example, the driving motor is a direct-current motor, the battery supply circuit may be formed so that the impact of the internal friction in motor and rotation bearings, as well as also the moment of inertia (that loads the motor upon start) of the motor shaft and of the wax disc, may be compensated so that the relative alteration (rather than the absolute value thereof) of the motor load is measured. In the use of the device according to the invention, a plurality of mutually identical discs are accessible, which are readily replaceable and which are coated with the different waxes supposed to be most suitable for the snow conditions in question. Among these, the wax that is thought to be most favourable is selected, and the same wax is evaluated by means of the device, the measuring equipment being set to zero for this wax. Next, the other discs (coated with other waxes) are tested. If, in that connection, a better wax is found, this one is noted and the instrument is set to zero for the same, etc. The proper setting to zero may be automatized by means of electronics, in a known way per se.

The pressing of the disc against the snow surface may be effected by, for instance, a weight, but presently it is preferred to use a spring device that affords a repetitive and conformal load of the disc against the snow surface. Of course, the spring may be adjustable for the setting of a selectable load.

The rotatable disc may be entirely coaxially coupled to the motor shaft via quick-coupling means, which afford quick and simple replacement of the discs. In that connection, the motor may be linearly guided and movable in the stand via bearings that afford a minimised kinetic friction.

In the following, the invention will be described by way of examples, reference being made to the appended drawing.

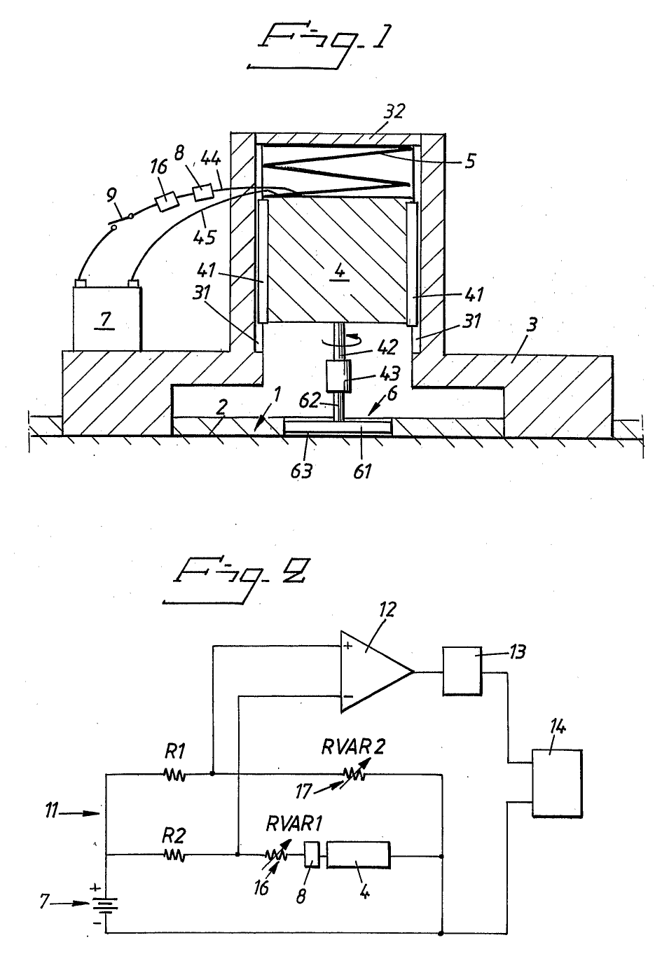

FIG. 1 shows schematically a device according to the invention in a side view.

FIG. 2 shows a circuit diagram of the device.

In FIG. 1, a cross-country skiing track 1 is shown having a bottom surface 2. A rotor 6 has a shaft shank 6 and a plate 61 perpendicular thereto, which plate on the bottom side thereof is provided with a layer 63 of a wax to be evaluated. The shank 62 connects via a quick coupling 43 to an output shaft 42 being concentric with the shank 62 and belonging to an electric motor 4, which is axially guided in a stand 3, which stably rests on the ground, in such a way that the disc 61 lies plane-parallelly to the bottom surface 2 of the skiing track. The motor 4 is shown guided for axial motion in the stand 3. As an example, it is shown that the motor casing has two axial diametrically opposite guides, which engage in the respective guiding grooves 31 in the stand 3. It should be obvious that the guiding is formed to be substantially frictionless. The stand 3 is shown to include a yoke 32, a spring 5 supporting against the yoke 32 and against the upper axial end of the motor 4, respectively, in order to produce a predetermined pressing force of the plate 61 against the bottom of the track 2.

Furthermore, a direct-current source 7 is shown in the form of an accumulator, the power-supply conductor 44, 45 of the direct-current motor 4 being connected to an accumulator pole each. The line 44 is shown to comprise a change-over switch 9, a variable resistor 16 and an ammeter 8.

The motor 4 is of the kind that has a substantially linear relationship between the current consumption and the torque of the shaft 42. The braking moment represented by the wax layer 63 on the plate 61 upon rotation of the plate 61, at the load in question against the bottom of the track 2, depends on the current that can be read by the ammeter 8 or by the setting of the resistor 16. By decreasing the resistance of the resistor 16 from a high value, the current that flows through the conductor 44 will reach a value at which the motor 4 is capable of setting the disc 61 in rotation. This represents a static coefficient of friction of the wax layer 63. The same coefficient of friction is of a substantial interest in respect of the “bite”, which the wax in question can give to a pair of cross-country skis that is to be used in the track 1.

By decreasing the resistance of the resistor 16, the current through the conductor 44 increases and increases the number of revolutions of the motor 4 up to a preselected range of revolutions at which the relative speed between the wax layer 63 and the bottom surface 2 of the track reaches a value corresponding to the one that applies in the type of skiing that is considered in respect of the evaluation of the wax layer 63. In that connection, the current flow through the conductor 44 or the setting of the resistor 16 is read again, the current corresponding to a torque required to rotate the disc/the rotor 6. From this, it is possible to derive a dynamic coefficient of friction of the wax layer 63 in question against the snow conditions in question in the bottom surface of the track 1 at a selected speed (number of revolutions) of the disc 6. Alternatively, for the same driving power, it is possible to evaluate the different numbers of revolutions of the different waxes.

The motor as well as the bearings thereof have an internal friction and the motor is further loaded upon start by the moment of inertia of the rotary parts of the motor, and these factors can be regarded to constitute a constant factor. By providing a Wheatstone bridge 11 in accordance with the diagram according to FIG. 2, it is possible to compensate for these substantially constant factors. At one side, the Wheatstone bridge is shown to contain two preferably mutually identical fixed resistors R1, R2, and at the other side, two likewise parallel resistance groups, namely a variable resistor RVAR2 (17) in one of the branches, and, in the other branch, a variable resistor RVAR1 (16), which is in series with the motor 4. By setting the correct value of the resistor 17, the voltage signal from the motor 4 is set to zero and the detected difference of voltage can be shown on a display 14. An amplifier 12 is shown connected across the bridge in order to give a high sensitivity. A low-pass filter 13 is connected between the amplifier 12 and the display 14. By means of the variable resistor 16 (RVAR1), it is possible to control the supply of current to the motor. In series with the variable resistor 16, an ammeter 8 is also shown.

By FIG. 1, it is outlined that the device may have a plurality of rotors 6, which can be switched quickly and readily by means of the quick coupling 43, the rotors 6 beforehand being provided with a respective layer 63 of the ski-waxes that are to be evaluated. By first evaluating waxes that provide an expedient bite within a certain region, subsequently it is possible to evaluate the wax or waxes that have the best dynamic friction properties and that hence a skier preferably should use when skiing in the track 1 in question.

In the embodiment example, the invention has been shown in connection with a motor 6, but it should be appreciated that the device according to the invention also may be formed with a plate that is linearly displaced along the bottom surface of the track 1 during driving by an electric motor 4, which preferably has a substantially linear relationship between the torque and current consumption, the plate being displaced while it is pressed against the surface 2 by a preselected constant pressure.

1. Device for the evaluation of at least one friction property of a ski wax against the surface of snow in a skiing track, comprising a disc carried by a stand and having a substantially planar working surface, on which a layer of wax that is to be evaluated is applied, members for the pressing of the disc by a preselected force against the snow surface and driving members for the driving of the disc in relation to the snow surface, wherein the driving members comprise an electric motor having a known relationship between the electric power consumption of the electric motor and the braking power of the disc and that means are provided for the readout of the electric power consumption of the motor, at least in the beginning of the displacement of the disc in relation to the snow surface.

2. Device according to claim 1, wherein the means are arranged to enable readout of the power consumption of the motor also at a stable displacement motion of the disc, preferably at a predetermined speed of the disc, for the evaluation of the dynamic coefficient of friction of the wax against the snow surface.

3. Device according to claim 1, wherein the device has a plurality of appurtenant identical discs, which can be switched by means of a quick coupling, the discs being provided with layers of different types of waxes that are to be compared with each other by means of the device.

4. Device according to claim 1, wherein the disc is arranged rotatable around a centrally located normal to the working surface coated with the wax layer.

5. Device according to claim 1, wherein a direct-current source is provided for the current supply of the direct-current motor and has a substantially constant voltage, and that the current consumption of the electric motor is read as a measure of the coefficient of friction of the wax.

6. Device according to claim 5, wherein compensating means are provided in the circuit of the electric motor in order to compensate for static factors in the power consumption of the motor, whereby the detected current consumption of the motor constitutes a measure of the coefficient of friction of the wax in question against the snow surface.

7. Device according to claim 2, wherein the device has a plurality of appurtenant identical discs, which can be switched by means of a quick coupling, the discs being provided with layers of different types of waxes that are to be compared with each other by means of the device.
